(19) United States
(12) Patent Application Publication
(10) Pub. No.: US 2025/0200849 A1
(43) Pub. Date: Jun. 19, 2025

(54) BOOKLIST COVER GENERATION METHOD, APPARATUS, DEVICE AND STORAGE MEDIUM

(71) Applicant: Beijing Zitiao Network Technology Co., Ltd., Beijing (CN)

(72) Inventor: Chuanqi JING, Beijing (CN)

(21) Appl. No.: 18/937,479

(22) Filed: Nov. 5, 2024

(30) Foreign Application Priority Data
Dec. 13, 2023 (CN) 202311715384.0

(51) Int. Cl. G06T 11/60; G06V 30/42

(52) U.S. Cl. CPC G06T 11/60; G06V 30/42; G06V 2201/131

(57) ABSTRACT

The present disclosure provides a booklist cover generation method, apparatus, device, and storage medium, wherein the method includes: acquiring booklist information about a target booklist, wherein the target booklist indicates a book collection, and the booklist information represents introduction information for the target booklist; determining cover image description information for the target booklist that includes description information corresponding to at least one characteristic dimension of booklist attributes, based on the booklist information; generating a cover image for the target booklist based on the cover image description information.

### CROSS-REFERENCE TO RELATED APPLICATIONS

The present application claims priority to and is based on a Chinese application with an application No. 202311715384.0 and a filing date of Dec. 13, 2023, the aforementioned application is hereby incorporated by reference in its entirety.

### FIELD OF THE INVENTION

Embodiments of the present disclosure relate to the technical field of computer technology, in particular to a booklist cover generation method, apparatus, device, and storage medium.

### BACKGROUND

With continuous development of electronic equipment, people can read or listen to books that they are interested in on a book reading platform through the electronic equipment. In order to help users quickly pick out the books that they are interested in, the book reading platform will not only show users book information about various books, such as book names, book covers, etc., but also show users text introduction information about various booklists. Among them, the booklist is a book collection, which includes a number of books determined based on attribute characteristics such as a topic, an author, a book type and so on.

### DISCLOSURE OF THE INVENTION

The invention provides a booklist cover generation method, apparatus, device, and storage medium, which can automatically and intelligently generate a cover image for a booklist, thereby improving an efficiency of producing the cover image for the booklist, improving matching between the cover image and books included in the booklist, and providing conditions for enhancing a recommendation effect of the booklist.

In the first aspect, an embodiment of the present disclosure proposes a booklist cover generation method, which includes:
acquiring booklist information of a target booklist, wherein the target booklist indicates a book collection, and the booklist information represents introduction information for the target booklist;
determining cover image description information for the target booklist that includes description information corresponding to at least one attribute characteristic dimension of booklist, based on the booklist information;
generating a cover image for the target booklist based on the cover image description information.

In a second aspect, an embodiment of the present disclosure proposes a booklist cover generation apparatus, which includes:
an information acquisition module configured to acquire booklist information of a target booklist, wherein the target booklist indicates a book collection, and the booklist information represents introduction information for the target booklist;
an information determination module configured to determine cover image description information for the target booklist that includes description information corresponding to at least one attribute characteristic dimension of booklist, based on the booklist information;
an image generation module configured to generate a cover image for the target booklist based on the cover image description information.

In a third aspect, an embodiment of the present disclosure proposes an electronic device, which includes:
a processor; and
a storage device for storing a computer program;
wherein the processor is used for calling and executing the computer program stored in the storage device, to implement the booklist cover generation method as described in the embodiment of the first aspect or its various implementations.

In a fourth aspect, an embodiment of the present disclosure proposes a computer-readable storage medium storing a computer program, which causes a computer to implement the booklist cover generation method as described in the embodiment of the first aspect or its various implementations.

In a fifth aspect, an embodiment of the present disclosure proposes a computer program product comprising program instructions, wherein the program instructions, when executed on an electronic device, cause the electronic device to implement the booklist cover generation method as described in the embodiment of the first aspect or its various implementations.

### DESCRIPTION OF THE DRAWINGS

In order to more clearly illustrate the technical solutions in the embodiments of the present disclosure, the drawings required for usage in the description of embodiments are briefly introduced below, obviously, the drawings in the following description are only some embodiments of the present disclosure, and it is obvious for those ordinary skilled in the art that other drawings can be derived based on these drawings without paying any creative labor.

FIG. 1 is a schematic flowchart of a booklist cover generation method provided by an embodiment of the present disclosure;

FIG. 2 is a schematic flowchart of another booklist cover generation method provided by an embodiment of the present disclosure;

FIG. 3 is a schematic flowchart of yet another booklist cover generation method provided by an embodiment of the present disclosure;

FIG. 4a is a schematic diagram of generating image content corresponding to cover image description information through a content generation module provided by an embodiment of the present disclosure;

FIG. 4b is a schematic diagram of a cover image provided by an embodiment of the present disclosure;

FIG. 4c is a schematic diagram of another cover image provided by an embodiment of the present disclosure;

FIG. 4d is a schematic diagram of yet another cover image provided by an embodiment of the present disclosure;

FIG. 5 is a schematic diagram of text styles in a text style library provided by an embodiment of the present disclosure;

FIG. 6 is a schematic diagram of adding descriptive keywords onto image content provided by the embodiment of the present disclosure;

FIG. 7 is a schematic block diagram of a booklist cover generation apparatus provided by an embodiment of the present disclosure;

FIG. 8 is a schematic block diagram of an electronic device provided by an embodiment of the present disclosure.

### DETAILED DESCRIPTION OF PREFERRED EMBODIMENTS

In the following, technical schemes in embodiments of the present disclosure will be clearly and completely described with reference to the drawings in the embodiment of the present disclosure. Obviously, the described embodiments are only a part of embodiments of the present disclosure, but not the whole of embodiments. According to embodiments in the present disclosure, all other embodiments obtained by those ordinary skilled in the art without creative works are encompassed in the protection scope of the present disclosure.

It should be noted that terms “first” and “second” in the description and claims of the present disclosure and the above drawings are used to distinguish similar objects, and are not necessarily used to describe a specific order or sequence. It should be understood that the data so used can be interchanged under appropriate circumstances, so that embodiments of the present disclosure described herein can be implemented in other orders than those illustrated or described herein. Furthermore, the terms “including” and “having”, and any variations thereof are intended to cover non-exclusive inclusion, for example, a process, method, system, product or server that includes a series of steps or units is not necessarily limited to those explicitly listed, but may include other steps or units not explicitly listed or inherent to these processes, methods, products or devices.

In embodiments of the present disclosure, the words “exemplary” or “for example” are used as examples, illustrations or explanations, and any embodiment or scheme described as “exemplary” or “for example” in embodiments of the present disclosure should not be interpreted as being more preferred or advantageous than other embodiments or schemes. To be exact, usage of the words “exemplary” or “for example” aims to present related concepts in a concrete way.

In the description of embodiments of the present disclosure, unless otherwise specified, “a plurality of” refers to two or more, that is, at least two. “At least one” means one or more.

Currently, most book reading platforms show users book information about various books and text introduction information about various booklists through a relevant page such as a recommendation page, in order to help users quickly pick the books that they are interested in from a large number of books. However, the booklist presented through the book reading platform usually does not have a cover image, which requires users to produce the cover image for the booklist themselves, which leads to low efficiency of producing the cover image, and the cover image produced by users may not match the books included in the booklist.

In order to solve the above technical problems, the inventive concept of the present disclosure is to determine cover image description information for a booklist based on booklist information of the booklist, and then generate a corresponding cover image for the booklist based on the cover image description information for the booklist, which can automatically and intelligently generate a cover image for a booklist, thereby improving an efficiency of producing the cover image for the booklist, improving matching between the cover image and books included in the booklist, and providing conditions for enhancing a recommendation effect of the booklist.

In the following, the technical scheme of the present disclosure will be explained in detail through some embodiments. The embodiments described below can be combined with each other, and the same or similar concepts or processes may not be repeated in some embodiments.

FIG. 1 is a schematic flowchart of a booklist cover generation method provided by an embodiment of the present disclosure. The booklist cover generation method provided by the embodiment of the present disclosure can be executed by a booklist cover generation apparatus. The booklist cover generation apparatus can be composed of hardware and/or software, and can be integrated into an electronic device. Optionally, the electronic device in the present disclosure can be various terminal devices or various servers, and exemplary terminal devices can be tablet computers, smart phones (such as Android phones, IOS phones, WindowsPhone phones, etc.), notebook computers, personal digital assistant (PDA), wearable devices, smart screens, etc., and the present disclosure does not impose any restrictions on the types of electronic devices. Among them, the terminal device can also be a User Equipment (UE), a terminal or a user equipment, which is not limited herein.

As shown in FIG. 1, the method includes the following steps:
S101, acquiring booklist information of a target booklist, wherein the target booklist indicates a book collection, and the booklist information represents introduction information for the target booklist.

In the present disclosure, the target booklist is any booklist displayed on any page in the book reading platform. Among them, any page in the book reading platform can be, but not limited to, at least one of a recommendation page, a hot list page and a hot search page.

In some alternative embodiments, the target booklist can be a book collection obtained by a book reading platform based on any attribute characteristics, for example, content information such as book author, book type and book creation time, etc. As an optional implementation, the book reading platform can determine a plurality of books related to a topic based on the topic, and take a collection of the plurality of books as the target booklist, which is a topic booklist at this time. For example, based on a topic “overbearing president”, a topic list such as “overbearing president's portfolio” can be generated. As another alternative implementation, based on the attribute characteristic of book creation time, the book reading platform can take a collection of a plurality of books belonging to this attribute characteristic as the target booklist “portfolio in XX period”. For example, based on the attribute characteristic of book author XX, a target booklist “author XX's portfolio” can be generated from multiple books created by the same author. As another alternative implementation, for any list, the book reading platform can obtain the top N hot-list books under the list, and generate a target booklist of hot-list category based on these hot-list books. In addition, the target booklist can also be a user booklist created by the user when using the book reading platform, and so on, and the present disclosure does not impose any restrictions on the target booklist.

Moreover, while creating the target booklist, the book reading platform or the user can create corresponding booklist information for the booklist, that is, create corresponding introduction information for each booklist, such as a booklist title of the booklist, brief information of the booklist and the number of books in the booklist, etc.

Furthermore, after the target booklist is created, the present disclosure can trigger acquisition of the booklist information of the target booklist at any time, or trigger acquisition of the booklist information of the target booklist after it is detected any book included in the target booklist is updated, and the present disclosure does not impose any restrictions on the timing of acquiring the booklist information of the target booklist.
S102, determining cover image description information for the target booklist that includes description information corresponding to at least one attribute characteristic dimension of booklist, based on the booklist information.

Among them, attribute characteristic dimensions of the booklist can include at least one of character action, character appearance and scene. Accordingly, the description information corresponding to the attribute dimension of the booklist can be understood as the information obtained by unfolded description for at least one of the character action, the character appearance and the scene.

Considering that the booklist information of the target booklist is mainly used to introduce contents of books included in the target booklist, the cover image belongs to an image representative of the booklist or books, that is, the visual aesthetic feeling and cultural connotation can be combined through the cover image, thus conveying main idea and content of the booklist or books. Therefore, based on the booklist information of the target booklist, the present disclosure can determine the cover image description information that can express the main idea and main content of the books included in the target booklist. Therefore, based on the determined cover image description information, a cover image that fits the target booklist can be generated subsequently.

In some embodiments, the cover image description information for the target booklist can be determined by, optionally, inputting the booklist information of the target booklist into an information determination model as input data, so as to process the above booklist information through the information determination model to obtain the cover image description information for the target booklist. Alternatively, the cover image description information for the target booklist can be determined based on the booklist information of the target booklist through some processing algorithms, and the present disclosure does not impose any restrictions on this.

The information determination model can optionally be any network model that supports determination of the image description information based on the booklist information. Among them, with respect to the network model, an initial neural network model can be continuously trained by taking booklist information of multiple booklists as training samples, and the main content and ideas of books in each booklist can be continuously analyzed during the training process, so as to generate cover image description information based on the main contents and ideas. Therefore, after the training of the neural network model is completed, the cover image description information corresponding to the booklist information can be accurately determined based on the network model.
S103, generating a cover image for the target booklist based on the cover image description information.

In some alternative embodiments, the present disclosure can input the cover image description information into a cover generation module to generate a cover image corresponding to the cover image description information through the cover generation module. Thereby, the cover image can be determined as the cover image for the target booklist.

The above-mentioned cover generation module can be any device or equipment that supports a production manner of automatically generating content by using AI technology, and the present disclosure does not impose any restrictions on it. The cover generation module in the present disclosure can optionally be, but not limited to, AIGC (AI-Generated Content) module.

According to the technical scheme disclosed in embodiments of the present disclosure, by acquiring booklist information of a target booklist, determining cover image description information for the target booklist based on the booklist information of the target booklist, and then generating a cover image for the target booklist based on the cover image description information for the target booklist. The present disclosure can automatically and intelligently generate a cover image for a booklist, thereby improving an efficiency of producing the cover image for the booklist, improving matching between the cover image and books included in the booklist, and providing conditions for enhancing a recommendation effect of the booklist.

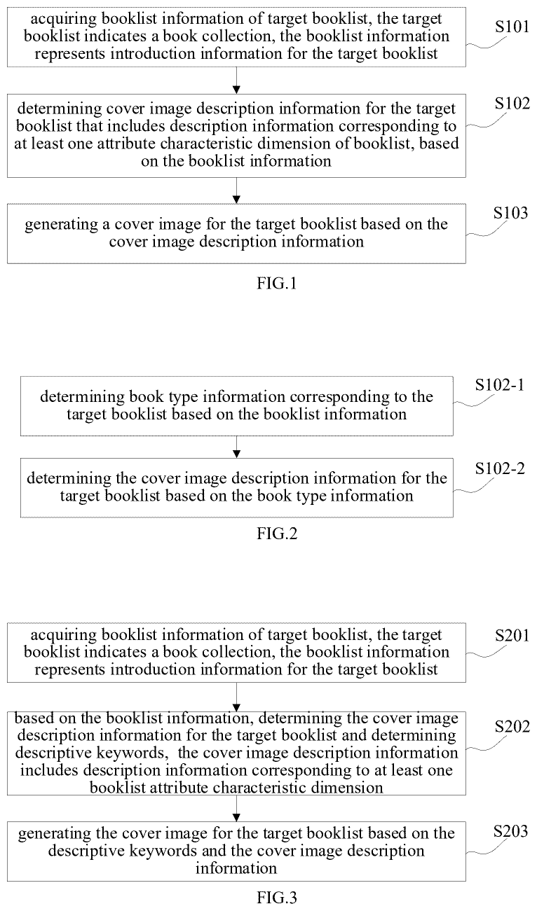

In some alternative embodiments, the booklist information of the target booklist in the present disclosure may include title information and brief information. Moreover, the title information and brief information in the booklist information are mainly used to introduce the books in the target booklist. It can be understood that the above booklist information can also be called introduction information of the target list. Therefore, on the basis of the above embodiment, the determination of the cover image description information for the target booklist in the present disclosure will be further explained with reference to FIG. 2. As shown in FIG. 2, the above S102 may include the following steps S102-1 to S102-2:
S102-1: determining book type information corresponding to the target booklist based on the booklist information.

Considering the booklist information of the target booklist may include title information and brief information, the book type information corresponding to the target booklist can be determined based on the title information and/or the brief information.

Therefore, in the present disclosure, the book type information corresponding to the target booklist can be determined based on the booklist information of the target booklist, in any of the following ways:

In a first way, the title information is input into a booklist type determination model as input data to obtain the book type information corresponding to the target booklist.

In a second way, the brief information is input into the booklist type determination model as input data to obtain the book type information corresponding to the target booklist.

In a third way, the title information and brief information both are input into the booklist type determination model as input data to obtain the book type information corresponding to the target booklist.

The above-mentioned booklist type determination model can optionally be as a correlation network model, and the booklist type determination model can continuously train a network model by using the title information and/or brief information of a large number of booklists, so that it can accurately determine the booklist type corresponding to the input title information and/or brief information based on the title information and/or brief information.

That is, in the present disclosure, the title information and/or brief information of the target booklist are input into the booklist type determination model, and the book type information corresponding to the target booklist output by the booklist type determination model can be obtained.
S102-2, determining the cover image description information for the target booklist based on the book type information.

In some alternative embodiments, the present disclosure can determine, based on the book type information of the target booklist, multiple pieces of candidate cover image description information corresponding to the book type information in a library of cover image description information. Then, any target cover image description information can be selected from the multiple pieces of candidate cover image description information, and the target cover image description information can be determined as the cover image description information for the target booklist.

In the present disclosure, when any target cover image description information is selected from multiple pieces of candidate cover image description information, a candidate cover image description information can be randomly selected from the multiple pieces of candidate cover image description information as the target cover image description information; alternatively, a candidate cover image description information can be selected from the multiple pieces of candidate cover image description information according to a preset selection rule as the target cover image description information, and so on, the present disclosure does not impose any restrictions on the specific implementation process of selecting any target cover image description information. Among them, the preset selection rule can be in the order from front to back, or in the order from middle to both sides successively, or in the order from back to front, etc., which is not limited here.

Considering that the booklist information of the target booklist may include keywords such as scene, character appearance and/or character action, etc., when the target cover image description information is selected from multiple pieces of candidate cover image description information, the present disclosure can also determine descriptive keywords based on the booklist information of the target booklist, and then select the target cover image description information from multiple pieces of candidate cover image description information according to the descriptive keywords.

In some alternative embodiments, determining the descriptive keywords based on the booklist information of the target list can be understood as extracting the descriptive keywords from the title information and/or brief information of the target list. The extraction of descriptive keywords can specifically include the following ways:

In a first way, words with high frequency of occurrence and meaning can be picked out from the title information and/or brief information by making statistic on information such as term frequency, etc., and the picked-out words are used as the descriptive keywords.

In the present disclosure, descriptive keywords can be extracted from the title information and/or brief information through a Term Frequency (TF)-Inverse Document Frequency (TDF) algorithm, that is, TF-IDF algorithm, a text ranking algorithm, etc.

It should be noted that if words picked out from the title information and/or brief information by the statistic-based extraction manner have the same frequency of occurrence, meaningful words can be picked out from the words with the same frequency of occurrence as descriptive keywords.

In a second way, word segmentation can be performed on the title information and/or brief information, and descriptive keywords can be picked out from all the segmented words according to part of speech.

In a third way, probability of title information and/or brief information can be predicted by using a language model, and descriptive keywords can be extracted from the title information and/or brief information based on the probability.

As an alternative implementation, the title information and/or brief information can be processed by a hidden Markov model or conditional random field, to extract descriptive keywords from the title information and/or brief information.

It should be noted that the above-mentioned implementations are only exemplary descriptions of embodiments of the present disclosure, instead of serving as specific restrictions on the present disclosure.

In some alternative embodiments, the above-mentioned process of selecting the target cover image description information from multiple pieces of candidate cover image description information according to the descriptive keywords can be specifically realized as: determining which one of the multiple pieces of candidate cover image description information includes the descriptive keywords, and determining the candidate cover image description information including the descriptive keywords as the target cover image description information.

Considering that the number of descriptive keywords determined based on the title information and/or brief information of the target booklist may be multiple, when selecting the target cover image description information from the multiple pieces of candidate cover image description information according to the descriptive keywords, it can be first determined which candidate cover image description information contains the descriptive keywords therein. Next, the number of descriptive keywords in the candidate cover image description information in which the descriptive keywords exist can be determined. Then, the candidate cover image description information with the largest number of descriptive keywords can be determined as the target cover image description information. In this way, the cover image description information that fits the target booklist better can be acquired, so that a cover image that more matches with books in the target booklist can be generated based on the cover image description information subsequently.

In some alternative embodiments, the above library of cover image description information can be interpreted as a database storing multiple pieces of cover image description information, and each cover image description information in the database has corresponding book type information. That is, the library of cover image description information stores the cover image description information according to mapping relationship between the cover image description information and the book type information.

Moreover, in the present disclosure, construction of the library of cover image description information may include the following steps:
S11, describing various book types according to preset booklist characteristic dimensions unfoldedly, so as to obtain multiple pieces of cover image description information corresponding to each books type information.
S12, constructing the library of cover image description information based on the multiple pieces of cover image description information corresponding to each book type information.

Among them, the preset booklist characteristic dimensions can include at least one of character action, character appearance and scene.

For example, assuming that the book type information corresponding to a booklist is ancient romance, the ancient romance will be described based on the three preset booklist characteristic dimensions of character action, character appearance and scene unfoldedly, so as to obtain multiple pieces of cover image description information corresponding to the ancient romance, as shown in the following table 1:

TABLE 1

| | | | | | Appearance | Appearance 2 | |
|---|---|---|---|---|---|---|---|
| | | | | Action | 1 (gender + | (not required | Full cover image |
| Type | serial | Number of | | (static | looks + | when there is | description |
| information | number | characters | scene | action) | clothes, etc.) | only one person) | information |
| Ancient | 1 | 2 | Brown | The man | The man has | The woman is | In the happy room, |
| romance | | | Gu Lou. | reads a | handsome | petite and | the man is hand at |
| | | | | book while | facial | wearing a red | hand, looking at the |
| | | | | sitting in | features and | skirt. | person he likes, |
| | | | | front of the | wears a red | | looking at the red |
| | | | | bed, and the | robe. | | candle on the table |
| | | | | woman is | | | with a pie mouth |
| | | | | making red | | | and holding his |
| | | | | candles. | | | chin in his hand. |
| Ancient | 2 | 2 | On the red | Men and | The man wore | The woman is | On the blood-red |
| romance | | | battlefield | women | an ice-blue | wearing a | battlefield, men |
| | | | | back-to- | robe, and the | light purple | wore ice-blue robes |
| | | | | back. | clothes were | dress and | stained with blood |
| | | | | | embroidered | holding a pike. | and held swords, |
| | | | | | with ink | | while women wore |
| | | | | | patterns. | | light purple dresses |
| | | | | | | | and held spears. |
| Ancient | 3 | 1 | Under the | The girl | Girls wear | | In under the |
| romance | | | Greenwood | smiled | ponytails | | greenwood tree, a |
| | | | Tree | back. | and bright | | woman wearing a |
| | | | | | yellow | | ponytail and a |
| | | | | | dresses. | | bright yellow |
| | | | | | | | costume skirt |
| | | | | | | | looked back and |
| | | | | | | | smiled. |
| Ancient | 4 | 1 | Riverbank | The girl | The girl is | | The girl in a light |
| romance | | | | looked into | wearing a | | green dress by the |
| | | | | the river | light green | | river looked at the |
| | | | | with a smile | dress. | | sea and smiled. In a |
| | | | | on her face. | | | trance, this world |
| | | | | | | | was eclipsed. |
| Ancient | 5 | 2 | In the temple | The man | The man is | The woman is | In the story, the |
| romance | | | | warmed | wearing a | wearing a long | man warms himself |
| | | | | himself in | white robe. | blue dress | in front of the fire, |
| | | | | front of the | | with long | holding a book in |
| | | | | fire and the | | black hair. | his hand; The |
| | | | | woman ran | | | woman came |
| | | | | in in the | | | running from the |
| | | | | rain. | | | rain, wearing a long |
| | | | | | | | blue dress. |

By using the above-mentioned way of describing the book type information of ancient romance according to the preset booklist characteristic dimensions unfoldedly, the same or similar unfolding description can be carried out for other book type information, so as to obtain multiple pieces of cover image description information corresponding to different book types. Then, according to the mapping relationship between the book type information and the cover image description information, multiple pieces of cover image description information corresponding to different book type information are stored as the data of the library of cover image description information, to obtain the library of cover image description information.

It can be seen that in the present disclosure, the book type information corresponding to the target booklist can be determined based on the booklist information, and then the range of determining the cover image description information for the target booklist can be narrowed based on the book type information, and then the target cover image description information corresponding to the target booklist can be accurately and quickly determined from multiple pieces of candidate cover image description information in a small range, so that the efficiency of generating the cover image for the booklist can be improved.

In another alternative implementation, it is considered that the booklist information of the target booklist is mainly used to introduce the books in the target booklist. Therefore, the present disclosure can determine cover text content for the target booklist through the booklist information introducing the books in the target booklist, and then generate a cover image having strong relevance to the target booklist based on the cover text content and the cover image description information, so that users can know the relevant information of the target booklist more intuitively and accurately based on the cover image, thereby improving recommendation effect of the booklist. Among them, the cover text content can be interpreted as text content displayed in the image. With reference to FIG. 3, the booklist cover generation method provided by the present disclosure will be further explained.

As shown in FIG. 3, the method may include the following steps:
S201, acquiring the booklist information of the target booklist, wherein the target booklist is a book collection, and the booklist information is used for representing the introduction information of the target booklist.
S202, according to the booklist information, determining the cover image description information for the target booklist and determining the descriptive keywords, wherein the cover image description information includes description information corresponding to at least one booklist attribute characteristic dimension.

The above-mentioned descriptive keywords can be interpreted as the cover text content used to generate the cover image for the target booklist.

In some alternative embodiments, determining the descriptive keywords according to the booklist information of the target booklist may include the following implementations:

In a first situation, the descriptive keywords can be determined according to title information of the target booklist.

In the present disclosure, the descriptive keywords can be obtained by extracting keywords from the title information of the target booklist.

In a second situation, at least one intention information can be determined according to the title information of the target booklist, and descriptive keywords can be determined based on the intention information.

As an optional implementation, determining the intention information and determining the descriptive keywords based on the intention information may include the following steps:

In first step, inputting title information into an intention determination model, to disassemble the title information by the intention determination model to obtain at least one intention information corresponding to the title information. Among them, each intention information can correspond to at least one intention dimension.

In the present disclosure, the intention dimension may include, but not limited to, at least one of theme, role, plot, style, author and evaluation.

The above intention determination model can optionally be a natural language processing model, and the intention determination model can continuously train a network model by using a large number of title information samples of booklists, so that it can accurately disassemble the input title information into at least one intention information based on the title information.

For example, assume the target booklist is a topic booklist and the title information of the topic booklist is the title information of the topic, then the title information of the topic can be disassembled into at least one intention based on the intention determination model, as shown in the following table 2.

TABLE 2

| | Title information of topic | Intention information |
|---|---|---|
| 1 | Sweet modern funny imagination \|\| | [“{\” theme \ “:\” modern statement \ “,\” role \ “:\” hostess |
| | The hostess has strong affinity and can | has strong affinity \ “,\” plot \ “:\” can communicate with |
| | communicate with animals. | animals \ “,\” style \ “:\” sweet \ “} |
| 2 | Are there any book that makes people | [“{\” theme \ “:\” modern statement \ “,\” evaluation \ “:\” |
| | impressed \|\| modern, ancient | make people impressed \ “}”] |
| | statements are appropriate ~ It doesn't | |
| | matter if the imagination is bigger. | |
| 3 | I'm already numb to reading, and now | [“{\” evaluation \ “:\” novel theme \ “, \” author \ “:\” good |
| | I can't interest in any novels. \|\| I'm tired | writing \ “}”] |
| | of seeing, anyone can help me? Is there | |
| | a novel with new theme and good | |
| | writing that people can keep reading? | |
| | Please tell me ! ! ! | |
| 4 | Is there a quick transmigration story | [“{\” Plot \ “:\” quick transmigration \ “}”] |
| | that can make me not skip a chapter? | |
| | The books I've been chasing recently | |
| | are all serialized, and there is no book | |
| | to read ... Is there anyone make | |
| | recommendation? | |
| 5 | ...... | ...... |

Step 2, determining the number of at least one intention information corresponding to the title information, if the number of intention information is less than a first number threshold, executing the third step, otherwise executing the fourth step.
Step 3, in response to the number of the intention information being less than the first number threshold, determining the title information as descriptive keywords.
Step 4, in response to the number of intention information being greater than or equal to the first number threshold, selecting one or more intention information from all intention information according to intention dimension priority, and determining the selected the one or more intention information as descriptive keywords, or determining the one or more intention information and title information as descriptive keywords.

Among them, the first number threshold is an adjustable parameter, which can be flexibly adjusted according to application requirements. In the present disclosure, for example, the first number threshold is optionally 2.

Considering that when the number of intention information is less than the first number threshold, main information of booklist in the target booklist may not be accurately described by using such little intention information, but the title information can completely describe the main information of the booklist in the target booklist, therefore, in the present disclosure, when the number of intention information corresponding to the title information is determined to be less than the first threshold, the title information can be directly determined as the descriptive keywords.

Further, when the number of intention information is greater than or equal to the second number threshold, the present disclosure can optionally determine the title information and at least one intention information as the descriptive keywords, or determine at least two intention information as the descriptive keywords. That is, when the number of intention information is greater than or equal to the second number threshold, the descriptive keywords can be selected from the title information and intention information.

Considering that each intention information may correspond to an intention dimension with different priority, for example, when the intention dimensions are theme, style, role and genre, the priorities of the intention dimensions can optionally be theme >style >role >genre. Therefore, in the present disclosure, the one or more intention information can be selected from all intention information according to the above-mentioned priorities of intention dimensions, so as to ensure that the obtained intention information can be more in line with the books in the target list.

It shall be noted that when at least two pieces of intention information are determined as descriptive keywords, optionally, intention information whose number is less than the second number threshold can be selected from all intention information, so that on the one hand, it can be ensured that the selected intention information can describe main contents of books in the target booklist, and on the other hand, it can be avoided that the number of intention information is too large to cause the finally generated cover image to have too many text contents, which may causes image information presented by the cover image to be too little, and a problem that the user's visual experience is poor to occur.

The above-mentioned second number threshold is an adjustable parameter, which can be flexibly set according to actual application requirements. In the present disclosure, the second number threshold is optionally 3, and is not limited in the present disclosure in any way.

In some alternative embodiments, it is considered that the descriptive keywords determined based on the intention information comprise the title information or both the title information and at least one intention information, wherein, the intention information is a minimum unit, that is, information that can't be disassembled, while the title information is information that can be disassembled, therefore, the present disclosure can optionally perform keyword extraction from the title information included in the descriptive keywords, and use the extracted keywords as the descriptive keywords, so as to reduce the length of text information displayed in the cover image corresponding to the target booklist, so that the cover image can be displayed with images as the main part and text information as the auxiliary part, thus attracting users' attention and improving the effect of recommending books to users.

It should be noted that in this embodiment, the execution order of determining the cover image description information for the target booklist and determining the descriptive keywords can be that first determining the cover image description information and then determining the descriptive keywords; or, first determining the descriptive keywords and then determining the cover image description information; alternatively, determining the cover image description information and the descriptive keywords synchronously, such execution order is not limited in the present disclosure.
S203, generating the cover image for the target booklist based on the descriptive keywords and the cover image description information.

After having obtained the descriptive keywords and cover image description information corresponding to the target booklist, the present disclosure can first generate image content based on the cover image description information, and then add the descriptive keywords onto the image content, so as to generate a cover image including text content and background content for the target booklist.

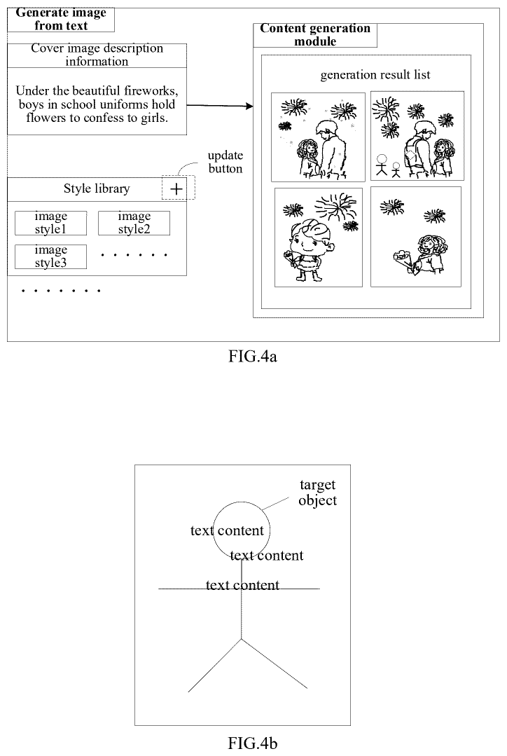

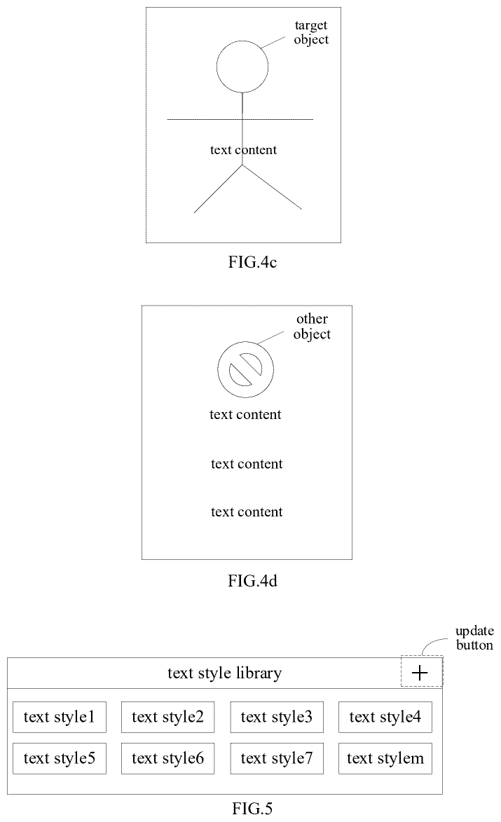

In some alternative embodiments, the present disclosure can input the cover image description information into a content generation module to generate image content corresponding to the cover image description information through the content generation module. Exemplary, as shown in FIG. 4a.

It should be understood that the above-mentioned content generation module can be any device or equipment that supports a production mode of automatically generating contents by using AI technology, and the present disclosure does not impose any restrictions on it. The content generation module in the present disclosure can optionally be, but not limited to, AIGC (AI-Generated Content) module.

In some alternative embodiments, before generating the image content based on the cover image description information, the present disclosure can also determine a target style for the image content, and supplement the cover image description information for the target booklist based on style description information for the target style. Then, the supplemented cover image description information is input into the content generation module, so that the content generation module can generate the image content corresponding to the supplemented cover image description information. In this way, the image content can be enriched, so that the final cover image is more distinctive and has higher recognition, which can further improve the recommendation rate of books.

In some implementations, the above-mentioned determining the target style for image content can determine any style selected by a user from a style library as the target style, or determine any style randomly and automatically selected from the style library based on the cover image description information as the target style, etc., which is not limited in the present disclosure.

The above-mentioned style library may be a preset database including multiple styles, and the database can be updated periodically, and the above-mentioned period can be flexibly set according to the actual needs, such as 7 days or 10 days, without any limitation.

That is, in the present disclosure, the determining the target style for image content may include: in respondence to selection of any style in the style library, taking the selected style as the target style; alternatively, selecting any style from the style library based on the cover image description information, and taking the selected style as the target style.

Considering that there may exist a target object such as a person and/or other animal in the image content, the descriptive keywords, if to be directly added onto any position in the image content, may block a main region of the target object such as the head and face, resulting in poor cover image effect, as shown in FIG. 4b.

Therefore, before generating the cover image for the target booklist based on the descriptive keywords and image content, the present disclosure can first perform image recognition on the image content to determine whether there exists a target object such as a person and/or other animal in the image content. If it is recognized that there exists a target object in the image content, a presentation position for the descriptive keywords can be determined based on the target object. Then, based on the presentation position for the descriptive keywords, the descriptive keywords can be added onto the image content to generate a cover image where the main region of the target object such as the head and face is not blocked, so that the presentation effect of the cover image for the target booklist can be improved, as shown in FIG. 4c. If it is recognized that there is no target object in the image content, the center position of the image content can be determined as the presentation position for the descriptive keywords, and then the descriptive keywords can be added onto the image content based on the center position to generate the cover image for the target booklist, as shown in FIG. 4d.

In some embodiments, the above-mentioned determining the presentation position for the descriptive keywords based on the target object may include the following situations:

In situation 1, when the target object is a person or other animal, the human body position of the person or body position of other animal can be determined by using an object pose estimation algorithm, such as OnePose. Then, the shoulder and the part of the human body below the shoulder can be determined as the presentation position for the descriptive keywords, or any region except other animal can be determined as the presentation position for the descriptive keywords.

In situation 2, when the target objects are a person and other animal, the human body position of the person can be determined by using an object pose estimation algorithm. Then, the shoulder and the part of the human body below the shoulder can be determined as the presentation position for the descriptive keywords.

In some alternative embodiments, in order to further improve the richness and diversity of the cover image for the target booklist, before adding the descriptive keywords onto the image content based on the presentation position for the descriptive keywords to generate a cover image in which the target object is not blocked, the present disclosure optionally first determines a type of descriptive keywords, wherein the types of descriptive keywords include title, intention and title intention. Then, according to the type of the descriptive keywords, a target text style for the descriptive keywords can be selected from a text style library. In turn, based on the presentation position for the descriptive keywords and the target text style, the descriptive keywords can be added onto the image content to generate a cover image for the target booklist.

The above descriptive keywords can include multiple pieces of intention information, or title information and intention information, or pure title information, therefore, based on the descriptive keywords, the type of descriptive keywords can be intuitively determined as the title type, the intention type or the title intention type.

Furthermore, the selecting the target text style for the descriptive keywords from the text style library according to the content type can optionally include picking out a plurality of candidate text styles corresponding to the type of the descriptive keywords from the text style library, and then picking out any one candidate text style from the plurality of candidate text styles as the target text style by adopting a random selection manner or in an order from front to back or from back to front, etc.

In addition, the text style library can be a database including a plurality of text styles, and the text styles in the database can be updated periodically, thus meeting a requirement of generating a personalized cover image for any booklist. The above-mentioned periodicity can be flexibly set according to actual application needs, such as 15 days, one month or six months, etc., without any limitation. For example, the text styles in the above-mentioned text style library can be as shown in FIG. 5.

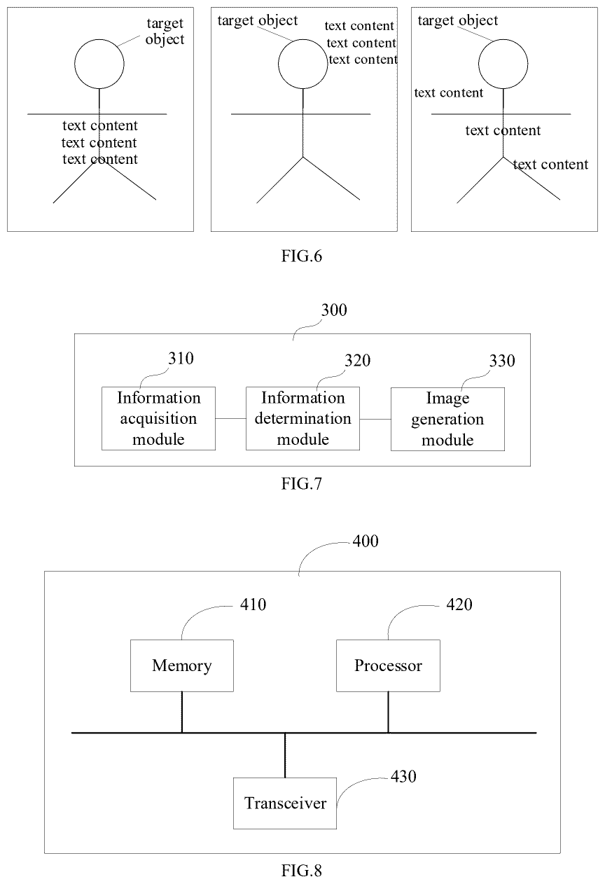

In some alternative embodiments, in the present disclosure, determination of the presentation position for the descriptive keywords can also be implemented based on the type of the descriptive keywords and the target object. For example, if it is determined that the type of the descriptive keywords is the title type, and the target object is a person or other animal, the shoulder and any position of the human body below the shoulder, or any region except other animal can be determined as the presentation position for the descriptive keywords. If it is determined that the type of descriptive keywords is intention type and the target object is a person, then any region that does not block the face area of the person can be determined as the presentation position for descriptive keywords, as shown in FIG. 6, for example, the presentation position for descriptive keywords in FIG. 6 may include that vertically or horizontally arranged in the image content at center, that vertically or horizontally arranged in the image content at the upper right corner, that diagonally arranged in the image content along any diagonal line of the image content, etc. If it is determined that the type of the descriptive keywords is the title intention type, and the target object is a person or other animal, the shoulder and any position of the human body below the shoulder can be determined as the presentation position for the descriptive keywords, and so on. The present disclosure does not impose any restrictions on determining the presentation position for the descriptive keywords based on the type of the descriptive keywords and the target object.

In some alternative embodiments, in order to generate a cover image in which the text is in harmony with the background, the present disclosure can determine a presentation size for the descriptive keywords by making the height of a single line of text not less than one fifth of the image content. Furthermore, according to the presentation position, presentation size and target text style for the descriptive keywords, the descriptive keywords can be added onto the image content. Considering that the presentation effect of the cover image would be the best when the height of a single line of text is one third of the image content, the present disclosure preferentially determines the height of a single line of text not less than one third of the image content as the presentation size for the descriptive keywords, and then adding the descriptive keywords to the image content according to the present size, so as to generate the best cover image for the target booklist.

The technical schemes according to embodiments of the present disclosure acquire the booklist information of the target booklist, determine the cover image description information for the target booklist based on the booklist information of the target booklist, and then generate the cover image for the target booklist based on the cover image description information for the target booklist. The present disclosure can automatically and intelligently generate the cover image for the booklist, thereby improving the production efficiency of the cover image for the booklist, improving the matching between the cover image and books in the booklist, and providing conditions for improving the recommendation effect of the booklist. In addition, the present disclosure determines the cover text content for the target booklist based on the booklist information of the target booklist, and then generates a cover image having strong correlation with the target booklist based on the cover text content and the cover image description information, so that users can know relevant information of the target booklist based on the cover image more intuitively and accurately, which provides conditions for further improving the recommendation effect of the booklist.

Next, with reference to FIG. 7, a booklist cover generation apparatus provided by an embodiment of the present disclosure will be described. FIG. 7 is a schematic block diagram of a booklist cover generation apparatus provided by an embodiment of the present disclosure.

As shown in FIG. 7, the book cover generation apparatus 300 may include an information acquisition module 310, an information determination module 320 and an image generation module 330.

The information acquisition module 310 may be configured to acquire booklist information of a target booklist, wherein the target booklist indicates a book collection, and the booklist information represents introduction information for the target booklist.

The information determination module 320 may be configured to determine cover image description information for the target booklist that includes description information corresponding to at least one attribute characteristic dimension of booklist, based on the booklist information.

The image generation module 330 may be configured to generate a cover image for the target booklist based on the cover image description information.

In an alternative implementation of the embodiment of the present disclosure, the information determining module 320 may include:
A first determination unit, configured to determine book type information corresponding to the target booklist based on the booklist information;
A second determination unit, configured to determine the cover image description information for the target booklist based on the book type information.

In an alternative implementation of the embodiment of the present disclosure, the booklist information of the target booklist may include title information and brief information, and the first determination unit may be specifically configured to input the title information and/or brief information into a booklist type determination model to obtain the book type information corresponding to the target booklist.

In an alternative implementation of the embodiment of the present disclosure, the second determination unit may be specifically configured to determine multiple pieces of candidate cover image description information corresponding to the book type information in a library of cover image description information; select any target cover image description information from the multiple pieces of candidate cover image description information; and determine the target cover image description information as the cover image description information for the target booklist.

In an alternative implementation of the embodiment of the present disclosure, the second determination unit may be further configured to determine descriptive keywords according to the list information of the target list; and select the target cover image description information from the multiple pieces of candidate cover image description information according to the descriptive keywords.

An alternative implementation of the embodiment of the present disclosure may further include:
a construction module, configured to describe different book type information unfoldedly according to preset booklist characteristic dimensions to obtain multiple pieces of cover image description information corresponding to each book type information; construct the library of cover image description information according to multiple pieces of cover image description information corresponding to each book type information.

In an alternative implementation of the embodiment of the present disclosure, the image generation module 330 may be specifically configured to input the cover image description information into a cover generation module to obtain the cover image for the target booklist.

In an alternative implementation of the embodiment of the present disclosure, the image generation module 330 may include:
a third determination unit, configured to determine the descriptive keywords according to the booklist information of the target list;
a generate unit, configured to generate the cover image for the target booklist according to the descriptive keywords and the cover image description information.

In an alternative implementation of the embodiment of the present disclosure, the third determination unit may be specifically configured to determine the descriptive keywords based on the title information of the target booklist; alternatively, determine at least one intention information based on the title information of the target booklist, and determine the descriptive keywords based on the intention information.

In an alternative implementation of the embodiment of the present disclosure, the third determination unit may be further configured to input the title information into an intention determination model to obtain at least one intention information corresponding to the title information, wherein each intention information corresponds to at least one intention dimension;
Where, the intention dimension may include one of theme, role, plot, style and evaluation.

In an alternative implementation of the embodiment of the present disclosure, the third determination unit may be further configured to, determine the title information is the descriptive keywords in response to the number of the intention information being less than a first number threshold; in response to the number of the intention information being greater than or equal to the first number threshold, select one or more intention information from all intention information according to priorities of the intention dimensions, and determine the selected one or more intention information as the descriptive keywords, or determine the one or more intention information and the title information as the descriptive keywords.

In an alternative implementation of the embodiment of the present disclosure, the generation unit may be specifically configured to: obtain image content according to the cover image description information; and generate the cover image for the target booklist based on the descriptive keywords and the image content.

In an alternative implementation of the embodiment of the present disclosure, the generation unit may be further configured to: when it is recognized that there exists a target object in the image content, determine presentation position for the descriptive keywords based on the target object; add the descriptive keywords onto the image content according to the presentation position for the descriptive keywords, generate the cover image for the target booklist.

In an alternative implementation of the embodiment of the present disclosure, the apparatus 300 may further include:
a style selection module, configured to select a target text style from a text style library according to the type of the descriptive keywords;
The generation unit may be further configured to add the descriptive keywords onto the image content according to the presentation position for the descriptive keywords and the target text style for the descriptive keywords to generate the cover image for the target booklist.

In an alternative implementation of the embodiment of the present disclosure, the apparatus 300 may further include:
a size determination module, configured to determine a presentation size for the descriptive keywords according to the image content;
The generation unit may be further configured to add the descriptive keywords to the image content according to the presentation position, the presentation size and the target text style for the descriptive keywords to generate the cover image for the target booklist.

It should be understood that the apparatus embodiment and the aforementioned method embodiment can correspond to each other, and similar descriptions can refer to the method embodiment. In order to avoid repetition, they will not be repeated here. Specifically, the apparatus 300 shown in FIG. 7 can execute the method embodiment corresponding to FIG. 1, and the aforementioned and other operations and/or functions of each module in the apparatus 300 are respectively used to realize the corresponding processes in each method in FIG. 1, and will not be repeated here for brevity.

The apparatus 300 of the embodiment of the present disclosure has been described above from the perspective of functional modules in conjunction with the figures. It should be understood that the functional module can be realized by hardware, by instructions in the form of software, and by a combination of hardware and software modules. Specifically, each step of the first aspect method embodiment in the embodiment of the present disclosure can be completed by an integrated logic circuit of hardware and/or an instruction in the form of software in the processor, and the steps of the first aspect method disclosed in combination with the embodiment of the present disclosure can be directly embodied as completion of execution by a hardware decoding processor or completion of execution by a combination of hardware and software modules in the decoding processor. Alternatively, the software module can be located in a mature storage medium in the present field such as random-access memory, flash memory, read-only memory, programmable read-only memory, electrically erasable programmable memory, registers, etc. The storage medium is located in a memory, and the processor reads information in the memory and completes the steps in the method embodiment of the first aspect in combination with its hardware.

FIG. 8 is a schematic block diagram of an electronic device provided by an embodiment of the present disclosure. As shown in FIG. 8, the electronic device 400 may include:
a memory 410 and a processor 420, wherein the memory 410 is used for storing a computer program and transmitting program codes to the processor 420. In other words, the processor 420 can call and run a computer program from the memory 410 to realize the booklist cover generation method in the embodiment of the present disclosure.

For example, the processor 420 can be used to execute the above-mentioned booklist cover generation method embodiment according to the instructions in the computer program.

In some embodiments of the present disclosure, the processor 420 may include, but not limited to:
General processor, Digital Signal Processor (DSP), Application Specific Integrated Circuit (ASIC), Field Programmable Gate Array (FPGA) or other programmable logic devices, discrete gate or transistor logic devices, discrete hardware components, and so on.

In some embodiments of the present disclosure, the memory 410 includes, but not limited to:
Volatile memory and/or non-volatile memory. Among them, the non-volatile memory can be Read-Only Memory (ROM), programmable read-only memory (PROM), erasable programmable read-only memory (EPROM), electrically erasable programmable read-only memory (EEPROM) or flash memory. The volatile memory may be a Random Access Memory (RAM), which can be used as an external cache. By way of illustration, without limitation, many forms of RAM are available, such as static RAM (SRAM), dynamic RAM (DRAM), Synchronous DRAM (SDRAM), Double Data Rate SDRAM (DDR SDRAM), Enhanced SDRAM (ESDRAM), synchronous link DRAM (SLDRAM), and direct memory bus random access memory (Direct Rambus RAM, DR RAM).

In some embodiments of the present disclosure, the computer program can be divided into one or more modules, which are stored in the memory 410 and executed by the processor 420 to accomplish the booklist cover generation method provided by the present disclosure. The one or more modules can be a series of computer program instruction segments that can accomplish specific functions, and the instruction segments are used to describe an execution process of the computer program in the electronic device.

As shown in FIG. 8, the electronic device 400 may further include:
a transceiver 430 that can be connected to the processor 420 or the memory 410.

The processor 420 can control the transceiver 430 to communicate with other devices, specifically, it can send information or data to other devices or receive information or data sent by other devices. The transceiver 430 may include a transmitter and a receiver. The transceiver 430 may further include antennas, and the number of antennas may be one or more.

It should be understood that all components in the electronic device can be connected through a bus system, wherein the bus system includes a power bus, a control bus and a status signal bus in addition to a data bus.

The present disclosure also provides a computer storage medium, on which a computer program is stored, which, when executed by a computer, causes the computer to execute the booklist cover generation method in the above method embodiments.

The present disclosure also provides a computer program product containing program instructions, which, when running on an electronic device, cause the electronic device to execute the booklist cover generation method in the above method embodiments.

When implemented in software, it can be fully or partially implemented in the form of a computer program product. The computer program product includes one or more computer instructions. The computer program instructions, when being loaded and executed on a computer, would generate flows or functions according to the embodiments of the present disclosure in whole or in part. The computer can be a general-purpose computer, a special-purpose computer, a computer network, or other programmable devices. The computer instructions can be stored in a computer-readable storage medium or transmitted from one computer-readable storage medium to another, for example, the computer instructions can be transmitted from one website, computer, server or data center to another website, computer, server or data center in a wired (such as coaxial cable, optical fiber, digital subscriber line (DSL)) manner or in a wireless (such as infrared, wireless, microwave, etc.) manner. The computer-readable storage medium can be any available medium that a computer can access, or a data storage device such as a server or a data center that contains one or more available media integration. The available medium may be a magnetic medium (e.g., floppy disk, hard disk, magnetic tape), an optical medium (e.g., digital video disc (DVD)), or a semiconductor medium (e.g., solid state disk (SSD)) and the like.

One of ordinary skill in the art can realize that the modules and algorithm steps described in connection with the embodiments disclosed herein can be implemented in electronic hardware, or a combination of computer software and electronic hardware. Whether these functions are implemented in hardware or software depends on the specific application and design constraints of the technical scheme. Those skilled in the art can use different methods to realize the described functions for each specific application, but this implementation should not be considered beyond the scope of the present disclosure.

In several embodiments provided by the present disclosure, it should be understood that the disclosed systems, devices and methods can be realized in other ways. For example, the apparatus embodiment described above is only schematic. For example, the division of the module is only a logical function division. In actual implementation, there may be other division methods, such as multiple modules or components can be combined or integrated into another system, or some features may be ignored or not implemented. On the other hand, the mutual coupling or direct coupling or communication connection shown or discussed can be indirect coupling or communication connection through some interfaces, devices or modules, which can be electrical, mechanical or other forms.

The modules described as separate components may or may not be physically separated, and the components displayed as modules may or may not be physical modules, that is, they may be located in one place or distributed to multiple network elements. Some or all of the modules can be selected according to actual needs to achieve the purpose of this embodiment. For example, each functional module in each embodiment of the present disclosure can be integrated into one processing module, or each module can exist physically alone, or two or more modules can be integrated into one module.

The above is only the specific implementation of the present disclosure, but the protection scope of the present disclosure is not limited to this. Any person familiar with this technical field can easily think of changes or substitutions within the technical scope disclosed in the present disclosure, which should be covered by the present disclosure. Therefore, the protection scope of the present disclosure should be based on the protection scope of this claim.

1. A booklist cover generation method, comprises:
acquiring booklist information of a target booklist, wherein the target booklist indicates a book collection, and the booklist information represents introduction information for the target booklist;
determining cover image description information for the target booklist based on the booklist information, wherein the cover image description information comprises description information corresponding to at least one attribute characteristic dimension of booklist;
generating a cover image for the target booklist based on the cover image description information.

2. The method of claim 1, wherein the determining cover image description information for the target booklist based on the booklist information, comprises:
determining book type information corresponding to the target booklist based on the booklist information;
determining the cover image description information for the target booklist based on the book type information.

3. The method of claim 2, wherein the booklist information of the target booklist comprises:
title information and brief information, and wherein the determining cover image description information for the target booklist based on the booklist information, comprises:
inputting the title information and/or brief information into a booklist type determination model to obtain the book type information corresponding to the target booklist.

4. The method of claim 2, wherein the determining the cover image description information for the target booklist based on the book type information, comprises:
determining multiple pieces of candidate cover image description information corresponding to the book type information in a library of cover image description information;
selecting any target cover image description information from the multiple pieces of candidate cover image description information; and determining the target cover image description information as the cover image description information for the target booklist.

5. The method of claim 4, wherein the selecting any target cover image description information from the multiple pieces of candidate cover image description information, comprises:
determining descriptive keywords based on the list information of the target list; and
selecting the target cover image description information from the multiple pieces of candidate cover image description information according to the descriptive keywords.

6. The method of claim 4, wherein the library of cover image description information is constructed through:
describing different book type information unfoldedly according to preset booklist characteristic dimensions to obtain multiple pieces of cover image description information corresponding to each book type information;
constructing the library of cover image description information based on the multiple pieces of cover image description information corresponding to each book type information.

7. The method of claim 1, wherein the generating the cover image for the target booklist based on the cover image description information, comprises at least one of:
inputting the cover image description information into a cover generation module to obtain the cover image for the target booklist, or
determining descriptive keywords based on the booklist information of the target list, and generating the cover image for the target booklist based on the descriptive keywords and the cover image description information.

8. The method of claim 7, wherein the determining descriptive keywords based on the booklist information of the target list, comprises:
determining the descriptive keywords based on the title information of the target booklist; or,
determining at least one intention information based on the title information of the target booklist, and determining the descriptive keywords based on the intention information.

9. The method of claim 8, wherein the determining at least one intention information based on the title information of the target booklist, comprises:
inputting the title information into an intention determination model to obtain at least one intention information corresponding to the title information, wherein each intention information corresponds to at least one intention dimension;
Where, the intention dimension comprises one of theme, role, plot, style and evaluation.

10. The method of claim 8, wherein the determining the descriptive keywords based on the intention information, comprises:
in response to the number of the intention information being less than a first number threshold, determining the title information as the descriptive keywords;
in response to the number of the intention information being greater than or equal to the first number threshold, selecting one or more intention information from all intention information according to priorities of the intention dimensions, and determining the selected one or more intention information as the descriptive keywords, or determining the one or more intention information and the title information as the descriptive keywords.

11. The method of claim 7, wherein the generating the cover image for the target booklist based on the descriptive keywords and the cover image description information, comprises:
obtaining image content according to the cover image description information;
generating the cover image for the target booklist based on the descriptive keywords and the image content.

12. The method of claim 11, wherein the generating the cover image for the target booklist based on the descriptive keywords and the image content, comprises:
when it is recognized that there exists a target object in the image content, determining a presentation position for the descriptive keywords based on the target object;
adding the descriptive keywords onto the image content according to the presentation position for the descriptive keywords, to generate the cover image for the target booklist.

13. The method of claim 12, further comprising:
selecting a target text style from a text style library according to the type of the descriptive keywords;
adding the descriptive keywords onto the image content according to the presentation position for the descriptive keywords and the target text style for the descriptive keywords to generate the cover image for the target booklist.

14. The method of claim 13, further comprising:
determining a presentation size for the descriptive keywords according to the image content;
adding the descriptive keywords onto the image content according to the presentation position, the presentation size and the target text style for the descriptive keywords to generate the cover image for the target booklist.

15. An electronic device, comprising:
a processor and a memory, wherein the memory is used for storing a computer program, and the processor is used for calling and running the computer program stored in the memory to execute:
acquiring booklist information of a target booklist, wherein the target booklist indicates a book collection, and the booklist information represents introduction information for the target booklist;
determining cover image description information for the target booklist based on the booklist information, wherein the cover image description information comprises description information corresponding to at least one attribute characteristic dimension of booklist;
generating a cover image for the target booklist based on the cover image description information.

16. The electronic device of claim 15, wherein the determining cover image description information for the target booklist based on the booklist information, comprises:
determining book type information corresponding to the target booklist based on the booklist information;
determining the cover image description information for the target booklist based on the book type information.

17. The electronic device of claim 15, wherein the generating the cover image for the target booklist based on the cover image description information, comprises at least one of:
inputting the cover image description information into a cover generation module to obtain the cover image for the target booklist, or
determining descriptive keywords based on the booklist information of the target list, and generating the cover image for the target booklist based on the descriptive keywords and the cover image description information.

18. A non-transitory computer-readable storage medium for storing a computer program that causes a computer to execute:
acquiring booklist information of a target booklist, wherein the target booklist indicates a book collection, and the booklist information represents introduction information for the target booklist;
determining cover image description information for the target booklist based on the booklist information, wherein the cover image description information comprises description information corresponding to at least one attribute characteristic dimension of booklist;
generating a cover image for the target booklist based on the cover image description information.

19. The non-transitory computer-readable storage medium of claim 18, wherein the determining cover image description information for the target booklist based on the booklist information, comprises:
determining book type information corresponding to the target booklist based on the booklist information;
determining the cover image description information for the target booklist based on the book type information.

20. The non-transitory computer-readable storage medium of claim 18, wherein the generating the cover image for the target booklist based on the cover image description information, comprises at least one of:
inputting the cover image description information into a cover generation module to obtain the cover image for the target booklist, or
determining descriptive keywords based on the booklist information of the target list, and generating the cover image for the target booklist based on the descriptive keywords and the cover image description information.
